(19) United States
(12) Patent Application Publication
(10) Pub. No.: US 2005/0047143 A1
(43) Pub. Date: Mar. 3, 2005

(54) Single light illumination system for a fluid tap

(76) Inventor: Joseph Edward Currie, Webster, NH (US)

Correspondence Address: JOSEPH E. CURRIE, 506 WHITE PLAINS RD., WEBSTER, NH, 03303-7112, US

(21) Appl. No.: 10/652,904

(22) Filed: Sep. 2, 2003

(51) Int. Cl. F21V 1/00

(52) U.S. Cl. 362/276

(57) ABSTRACT

The present invention discloses a single light illumination system for a comestible fluid tap. The single light, in the form of a single or multi-color light emitting diode, is insertion injection molded into a tap in position to illuminate the lower surfaces of a beer dispenser upon which the tap is mounted. Means for sensing fluid flow, temperature, and pressure, are within the tap for the purpose of illuminating alarm indicating LEDs displayed on the tap. Separate electrical circuits, with externally accessible electrical jumpers for programming different modes of controlled illumination, are provided for a single color LED, and for a multi-color LED. Also a beer tap bank accessory is described that provides for a horizontal mounting rail located beneath multiple taps, into which illuminating accessories are slid. Illuminating accessories are slid into the mounting rail and positioned beneath each tap of a multi-tap bank.

### CROSS REFERENCE TO RELATED APPLICATIONS

(Not Applicable)

### BACKGROUND OF THE INVENTION

This invention relates to comestible fluid taps and more particularly to comestible fluid taps with integrated illumination and the means for monitoring the flow, temperature, and pressure of the dispensed fluid.

U.S. Pat. No. 5,491,617 issued to Joseph E. Currie on Aug. 4, 1996 discloses an illumination device that illuminates a tap handle and an area proximate to a tap outlet. A remote light source, comprised of two lamps, directs illumination from the first lamp, through a first light conduit, into the tap handle when there is no fluid flow. When activated by a tap handle controlled tilt switch, the first lamp is switched off and the second lamp switched on. Illumination from the second lamp is communicated through a second light conduit where it is connected to the outlet of the tap.

U.S. Pat. No. 4,979,641 issued to Charles S. Turner on Dec. 25, 1990 discloses a computerized beverage dispensing system where a fitting with an electrically controlled valve, attached to a tap, is controlled by a computer. Pressure and temperature transducers are installed in the fitting to measure those parameters of the fluid flow and input those measurements into the computer for control of the fluid dispensing valve.

Neither of the above cited patents taken either singly or in combination disclose the arrangement of features in the instant invention as disclosed in this application.

### SUMMARY OF THE INVENTION

The present invention discloses a new technology single source illumination system for a comestible fluid tap. This new technology tap is formed using a plastic insertion injection molding process that positions the single light emitting diode with attached collar and focusing lens, herein after the LED, within the optically conductive plastic or acrylic body of the tap. The main body of the tap may be of an optically opaque or optically non-conductive plastic that is co-extruded with a combination LED and optically conductive portion of the tap. The LED that is insertion injection molded within the body of the tap is positioned to direct the solid state LED generated colored illumination toward the lower surfaces of the beer dispenser upon which the tap is mounted.

Two separate magnetically actuated electrically normally open switch contacts are located within the tap adjacent to the horizontally disposed metallic flow control valve. Each magnetic switch is located on the same horizontal plane as, and adjacent and parallel to each side of the metallic flow control valve-actuating rod. These two magnetically actuated contacts, in conjunction with externally accessible electrical jumpers, determine the mode of operation of the imbedded illumination LED. The tap may have audible volume or audible frequency sensing means, and or illumination intensity sensing means, co-extruded within, or installed thereon, that may control and change the intensity and or color of illumination from the imbedded illumination LED when exposed to sound or light changes

Conditions unfavorable to the continued operation of the tap such as, but not limited to, abnormally high temperature of the dispensed liquid, lack of dispensed liquid flow, or below normal dispensed liquid pressure, would trigger a visual alarm indication such as flashing the imbedded illumination LED at a high rate, or changing the color of the illumination LED, or switching the illumination LED off. Each alarm sensor has a form “C” contact with a normally open and a normally closed contact. The normally closed contacts are wired in series and connected to the illumination LED series circuit. The normally open sides of the alarm contacts are connected in parallel. The summation of the parallel alarm contacts is connected through a flashing contact to the illumination LED. The output of each alarm contact is also connected to a small indication LED mounted within the top section of the tap that will illuminate in a steady state and be labeled to indicate the source sensor of the signaled alarm. The visual illumination LED alarm indication will continue until the alarming condition is corrected, or until an over-ride switch is operated. The sensors, transducers, or other alarm condition determining means may be located within or without the fluid-dispensing tap.

The first embodiment of this instant invention utilizes a single color LED. It combines a turbine flow and volume measuring valve with a form “C” contact, a pressure sensor with a for “C” contact, and a temperature sensor with a form “C” contact. The normally closed side of each of these contacts is wired in series and connected to a series combination of a photocell varister and an audio sensor varister. This circuit is connected in turn to the series combination of the two magnetically actuated contacts adjacent to the horizontally disposed fluid flow valve-actuating rod. Externally accessible electrical jumpers, either in series or in parallel with the photocell varister, the audio sensor varister, and both magnetically actuated switch contacts, program the mode of operation of the imbedded illumination LED.

The second embodiment of this invention uses a two color LED. It combines a turbine flow and volume-measuring valve with a form “C” contact, a pressure sensor with a form “C” contact, and a temperature sensor with a form “C” contact. The normally closed side of each of these contacts is wired in series and connected through the first magnetically actuated switch and through the normally closed side of relay K1 to the first color lead of the dual color illumination LED. Source voltage is connected through the second magnetically actuated switch to the coil of relay K1. The normally open side of the form “C” contact of relay K1 is connected to the second color lead of the dual color illumination LED. Externally accessible electrical jumpers either in series or in parallel with the photocell varister, the audio sensor varister, and both magnetically actuated switch contacts program the mode of operation of the dual colored illumination LED.

In a third embodiment of this invention a programmable logic controller within or without the tap, with input from fluid flow sensing means, and or fluid volume of flow measuring means, located within or without the tap, can control electrical power to the illumination LED within the tap, or change the intensity of illumination of the illumination LED within the tap. The PLC may be programmed to vary the intensity of illumination from the imbedded illumination LED to coincide with fluid flow variations, or if a multi-color illumination LED is used, the same means may vary the color of the illumination from the LED.

In a fourth embodiment of this invention a beer tap bank accessory is described. A LED with attached collar and focusing lens is insertion injection molded into a portable illumination-dispensing device made of optically conductive acrylic or plastic. The illumination device has electrically connective contact pads above and below the portable illumination dispenser along the front top and bottom edges. The mounting section of the device also has compressible spring tension means on the back surface. The mounting section of the device is designed to slide into a mounting rail with electrically conductive stripes inside of overhanging top and bottom edges that meet and contact the front conductive pads of the portable illumination device. The length selectable rail is mounted beneath a row of beer taps and a portable illumination device for each tap is compressed and slid into the rail and positioned beneath each tap. When each illumination device is released, electrical contact between the electrical connective pads of the device and the electrically conductive strips of the rail is made, and illumination of the lower surfaces of the beer dispenser upon which the portable rail and illumination dispensers are mounted is accomplished.

### BRIEF DESCRIPTION OF THE DRAWINGS

FIG. 1A is a side view of the tap.

FIG. 1B is a front view of the tap.

FIG. 2 is an electrical schematic diagram of a single color LED lighting system.

FIG. 3 is jumper/results table for a single color LED lighting system.

FIG. 4 is an electrical schematic diagram of a multi-color LED lighting system.

FIG. 5 is a jumper/results table for a multi-color LED lighting system.

FIG. 6A is a front view of a mounting rail.

FIG. 6B is an end view of a mounting rail.

FIG. 6C is a side view of a portable illumination device.

### DETAILED DESCRIPTION OF THE PREFERRED EMBODIMENTS

The present invention is a single light illumination system for a comestible fluid tap.

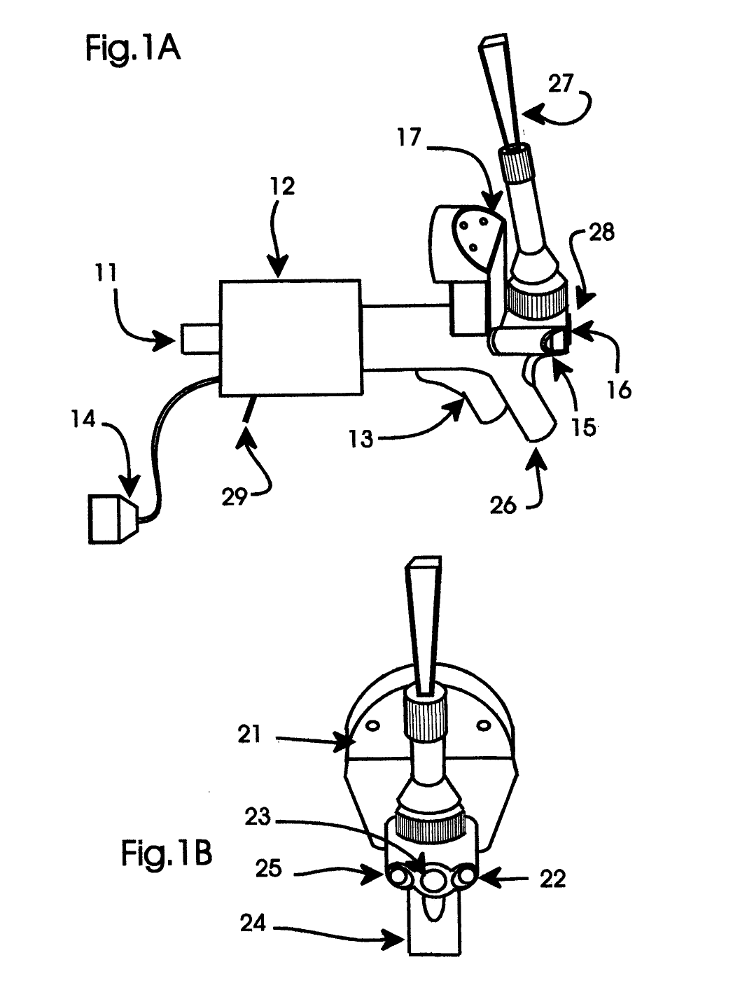

FIG. 1A depicts a side view of a tap with a single light illumination system installed therein. The area 13 below and behind tap outlet 26 is where the single illuminating LED is insertion injection molded into the tap. This side view shows the locations 15 and 28 of a first and second magnetically actuated switch. Fluid under pressure flows into the tap at 11 and through a turbine flow and volume measuring valve and temperature and pressure sensors located at 12. Direct current source electrical power available at electrical plug 14 flows through the normally closed contacts of the flow valve and temperature and pressure sensors of location 12. This power then flows through the normally open magnetically actuated switches at 15 and 28 when the liquid flow control valve 16 is operated to the open condition. A flow, pressure, or temperature alarm sensed by the valve or sensors at 12 would be communicated to labeled indication LEDs at 17. This indicated alarm would also flash the illumination LED at 13 until the alarm condition was corrected or the alarm bypass switch 29 was operated.

FIG. 1B is a front of a tap with a single light illumination system installed.

As shown, 24 is a front view of the liquid dispensing spout, 25 and 22 are two magnetically actuated normally closed electrical contacts that close upon the opening of fluid control valve 23. The labeled alarm indicators are shown on the alarm display panel 21.

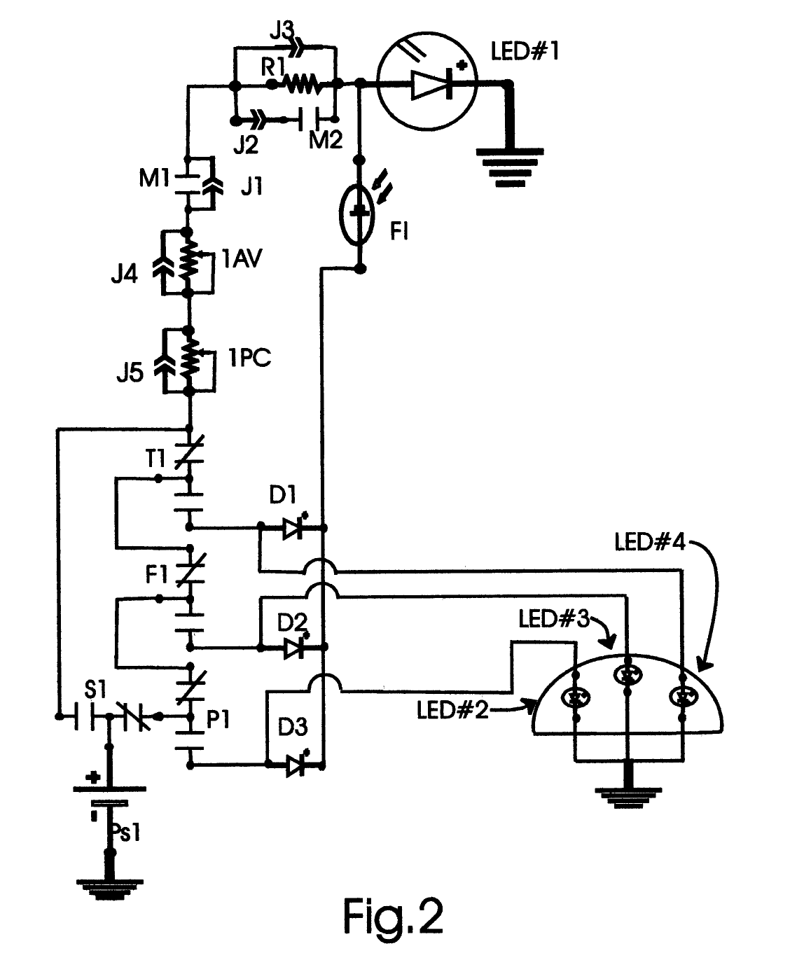

FIG. 2 is a schematic diagram of a single color LED lighting system for a comestible fluid-dispensing tap.

DC electrical current from power supply Ps1 flows through the normally closed side of alarm cutout switch S1, and then through the three normally closed alarm contacts P1 (pressure), F1 (lack of flow), and T1 (temperature). This DC current then flows through the photocell modulating output 1PC, the audio modulating output 1AV, the first magnetically actuated switch M1, and through either resistor R1 or the second magnetically actuated switch M2, to the anode of illuminating LED#1. Operation of any of the three alarm contacts P1, F1, or T1 will open the normal DC current path to LED1, and connect the dc current through one of the three isolating diodes D1, D2, or D3, and then through flasher F1 to LED#1. Operation of any of the three alarm contacts will also connect DC current to the appropriate alarm indication LED #2, #3, or #4.

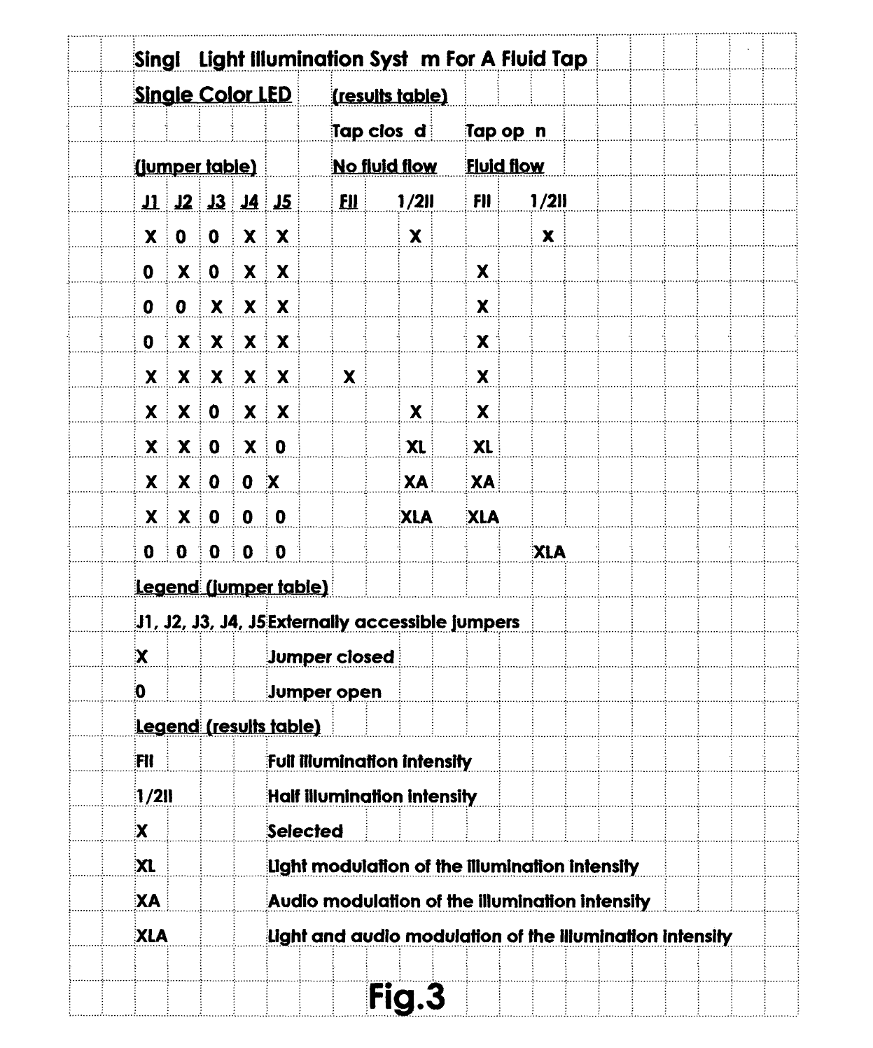

FIG. 3 is an electrical jumper table for the five jumpers of the electrical circuit as depicted in FIG. 2, and a results table for different programming configurations of the five jumpers, J1, J2, J3, J4, and J5.

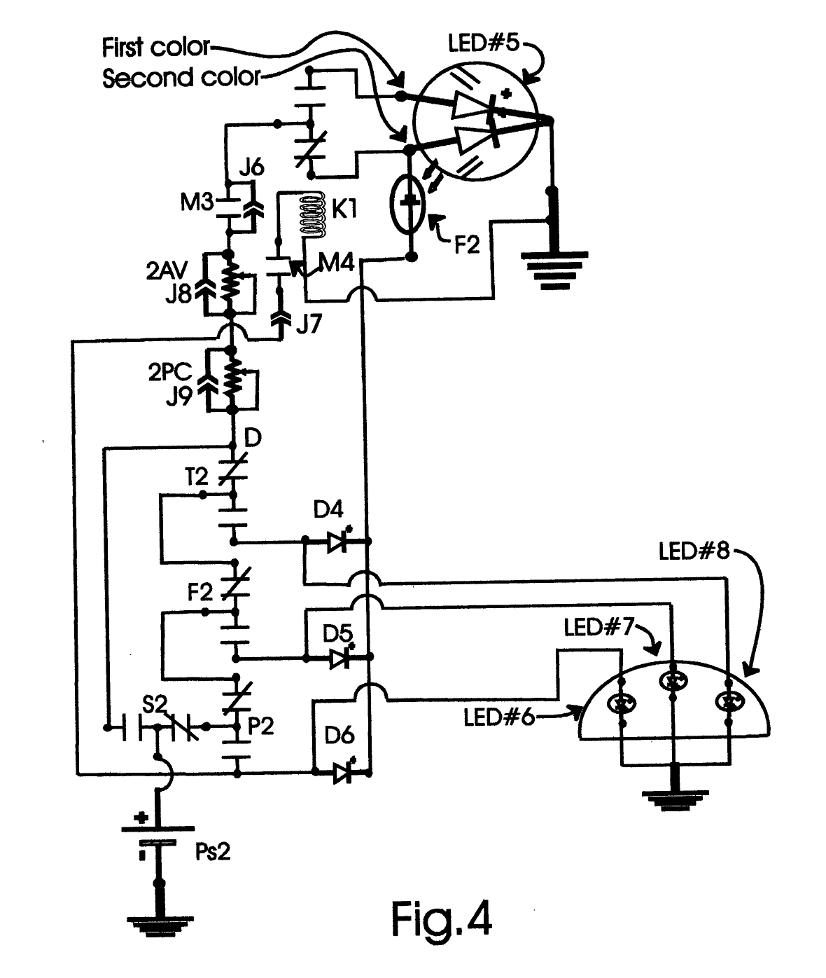

FIG. 4 is a schematic diagram of a single multi-color LED lighting system for a comestible fluid-dispensing tap.

DC electrical power from power supply Ps2 flows through the normally closed side of alarm cutout switch S2, and then through the three normally closed contacts P2 (pressure), F2 (lack of fluid flow), and T2 (temperature). This DC current then flows through the photocell modulating output 2PC, the audio modulating output 2AV, the first magnetically actuated switch M3, and through the normally closed side of the K1 relay contact to the second color lead of multi-color LED#5. Opening the tap fluid valve will close magnetically actuated switch M4 and energize relay K1 closing the normally open K1 relay contact. The DC current then flows to the first color lead of multi-color LED#5. Operation of any of the three alarm contacts P1, F1, or T1 will open the normal DC current path to multi-color LED#5, and connect the DC current through one of three isolating diodes D4, D5, or D6, and then through flasher F2 to multi-color LED#5. Operation of any of the three alarm contacts will also connect DC current to the appropriate alarm indication LED#6, #7, or #8.

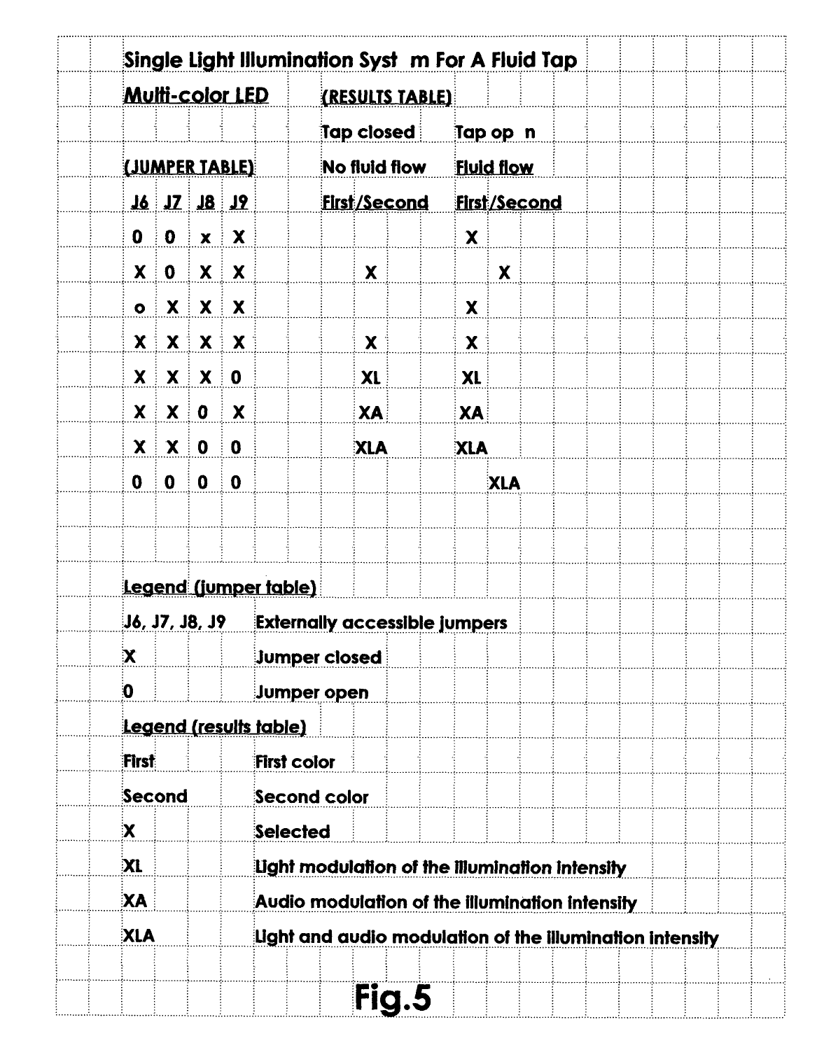

FIG. 5 is an electrical jumper table for the four jumpers of the electrical circuit as depicted in FIG. 4, and a results table for different programming configurations of the for jumpers, J6, J7, J8, and J9.

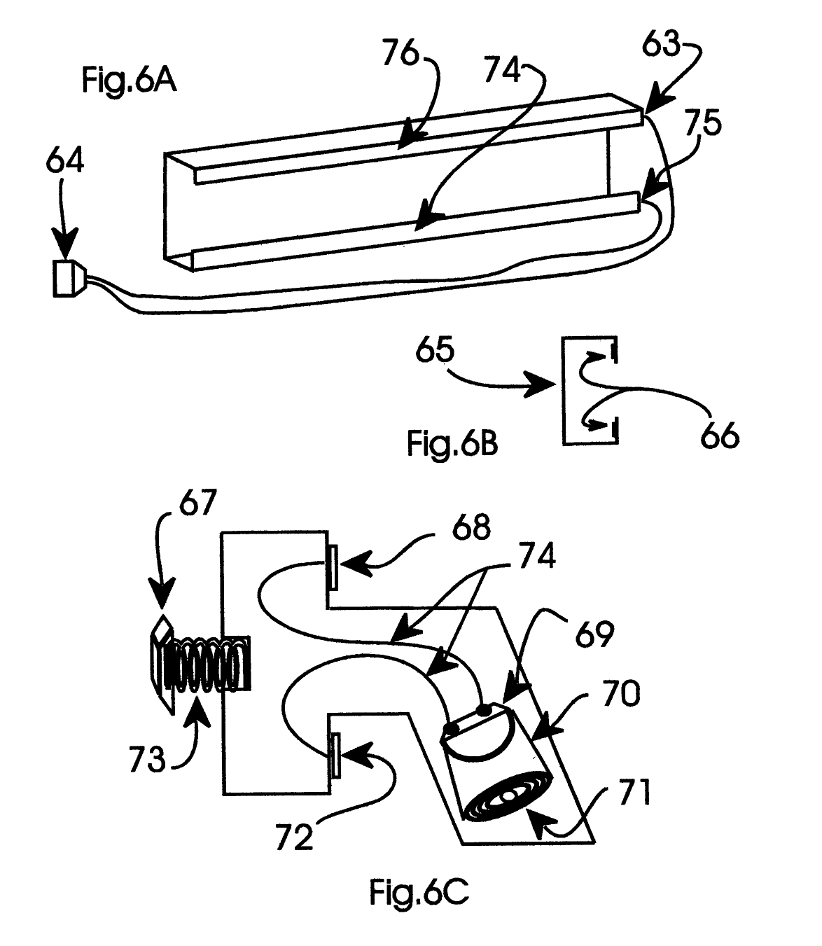

FIG. 6A depicts amounting rail for a beer tap bank accessory that illuminates the lower portions of a beer dispenser upon which multiple beer taps are mounted.

Electrical plug 64 connects positive and negative DC electrical power to a top 63 and bottom 75 electrical conductive strips that extend the length of the rail inside of top edge 76 and bottom edge 74.

FIG. 6B depicts an end view of the mounting rail 65.

The end view of the rail length spanning electrical conductors 66 is indicated.

FIG. 6C shows a side view of a portable illumination device that slides into a mounting rail.

A single color LED 69 is insertion injection molded into an acrylic illumination device with collar 70 and focusing lens 71. Electrical conductors 74 are connected individually to electrical contact pads 68 and 72. Compressible coil spring 73 is attached to the back of the illumination device, and cap 67 is affixed to the end of spring 73 to facilitate sliding the illumination accessory into the mounting rail by decreasing the sliding resistance of the spring when the spring is compressed. Releasing the pressure necessary to compress the spring to slide the illumination accessory into the mounting rail will cause the electrical contact pads 68 and 72 to contact the lengthwise electrical conductive strips of the mounting rail, energize LED 69, and illuminate the lower surfaces of the beer dispenser.

1. A single light source illumination system for a comestible fluid tap, said system comprising:
a single light source illumination system where the single illuminating light source is a single light emitting diode with attached collar and focusing lens;
means for indicating alarm conditions of the dispensed fluid as part of the tap;
means for monitoring the flow, temperature, and pressure of the dispensed fluid as part of the tap;
a first electrical system for operating said single illuminating light source in different modes programmed by externally accessible electrical jumpers when said light source is a single-color light emitting diode;
a second electrical system for operating said single illuminating light source in different modes programmed by externally accessible electrical jumpers when said light source is a multi-color light emitting diode.

2. The single light source illumination system of claim 1 wherein:
said light emitting diode with attached collar and focusing lens is insertion injection molded into said comestible fluid tap;
said light emitting diode is a single color light emitting diode;
said light emitting diode is a multi-color light emitting diode.

3. The electrical system of claim 1 is designed with two separate magnetically actuated switches with normally open electrical contacts, and said switches are located within the tap adjacent to the horizontally disposed metallic flow control valve;
said magnetically actuated switches are further located on the same horizontal plane as, and adjacent and parallel to, each side of the metallic flow control valve-actuating rod.

4 The single light source illumination system of claim 1 wherein:
said means for indicating alarm conditions of the dispensed fluid are a part of the tap and include a light emitting diode alarm indication and status panel with individual inputs from the normally open side of form “C” alarm contacts;
said means for indicating alarm conditions as part of the tap include a built in turbine flow and volume measuring valve with an electrical form “C” output contact;
said means for indicating alarm conditions as part of the tap include a temperature sensor that allows adjusting the operating set point temperature of the form “C” output contact;
said means a part of the tap for indicating alarm conditions further including a built in pressure sensor that allows adjusting the operating pressure set point of the form “C” output contact.

5. A first electrical system of claim 1 is designed to operate a single color light emitting diode at low and high power settings as programmed by externally accessible electrical jumpers and operation of integral magnetically actuated normally open switches.

6. A second electrical system of claim 1 is designed to change the colors of a multi-color light emitting diode as programmed by externally accessible electrical jumpers and operation of integral magnetically actuated normally open switches and an integral relay.

7. A first and a second electrical systems of claim 1 are designed to flash the illumination light emitting diode at a fast flash rate when one or more alarm conditions of the dispensed fluid exist.

8. The alarm conditions of claim 5 include temperature, pressure, and lack of dispensed fluid flow.

9. The temperature, pressure, or lack of fluid flow alarms of claim 6 are signaled by operation of the associated alarm contact that opens the normally closed series contact to the illuminating light emitting diode and closes the normally open parallel contact to the alarm flasher;
said alarm contact, and the series string of three alarm contacts, can be bypassed to maintain operation of the illumination light emitting diode by operating an alarm bypass switch.

10. The electrical system of claim 1 including a varister type output from an audio sensor and a varister type output from an illumination or light sensor;
said varister type outputs are connected in series with each other, in series with alarm contacts, and in series with the electrical current flowing through the illumination light emitting diode;
said varister type outputs may be bypassed by externally accessible electrical jumpers.

11. The multi-color light emitting diode of claim 1 is color changed when an integral magnetically actuated switch is operated connecting electrical power to an integral relay, changing condition of the relay form “C” contact that disconnects said electrical power from the first color lead and connects said electrical power to the second color lead of said multi-color light emitting diode.

12. A comestible fluid tap with a single illuminating light emitting diode that may be a single or multi-color diode, that is insertion injection molded within said fluid tap, providing for illumination of the lower surfaces of a beer dispenser upon which said tap is mounted, comprising:
a first electrical circuit programmed by externally available electric jumpers to change the illumination intensity of said single color light emitting diode;
a second electrical circuit programmed by said externally available electrical jumpers to change the color of a single multi-color light emitting diode.

13. A comestible fluid tap with a single illuminating light emitting diode that may be a single or multi-color light emitting diode molded within said fluid tap, providing for illumination of the unit upon which said tap is mounted, comprising:
a fluid flow sensing means;
a fluid volume of flow sensing means;
a programmable logic controller, or PLC, with inputs from said fluid flow sensing means, and or said fluid volume of flow sensing means, that can control electrical power to said illumination light emitting diode;
said PLC may control electrical power on and off to said light emitting diode, may change the illumination intensity of said light emitting diode, or may change the illuminating color of said light emitting diode.

14. A portable illuminating beer tap bank accessory that continuously or intermittently illuminates the lower surfaces of the beer dispenser beneath each tap that is mounted on the beer dispenser, and is comprised of:
a mounting rail approximately the length of a beer tap bank;
two or more conductors for electrical connectivity the length of said mounting rail;
a portable illuminating accessory or accessories that slides into said mounting rail.

15. The mounting rail of claim 14 where said rail has two or more conductive stripes secured to inner surfaces of said rail, the length of said rail, in a manner that allows two or more electrical connections to be made to each illumination accessory that is slid into said mounting rail.

16. The mounting rail of claim 14 where said rail has three or more conductive stripes of any length, secured to inner surfaces of said rail, in a manner that allows two or more electrical connections to be made to each illumination accessory that is slid into said mounting rail.

17. The portable illuminating accessory of claim 14 where a single color light emitting diode, or a multi-color light emitting diode with attached collar and focusing lens, is insertion injection molded into an illumination conductive acrylic or other plastic device in a shape conducive to being slide into said mounting rail of claim 14.

18. The portable illuminating accessory of claim 14 where two or more external electrically conductive surfaces are electrically connected to said light emitting diode.

19. The portable illuminating accessory of claim 14 where compression spring tension means is attached to the back surface of said accessory;
said spring tension means can include a compressible coil spring with a plastic cap or cover piece on the end that contacts the inner surface of the mounting rail to reduce sliding friction, or metal spring tension clips mounted in a horizontal direction.
